(19) United States
(12) Patent Application Publication
(10) Pub. No.: US 2025/0052964 A1
(43) Pub. Date: Feb. 13, 2025

(54) OPTICAL DEVICE AND OPTICAL TRANSCEIVER

(71) Applicant: FUJITSU OPTICAL COMPONENTS LIMITED, Kawasaki-shi (JP)

(72) Inventors: Yamato IWAMA, Kawasaki (JP); Hirohiko SONODA, Sapporo (JP); Satoshi IDE, Yokohama (JP)

(73) Assignee: FUJITSU OPTICAL COMPONENTS LIMITED, Kawasaki-shi (JP)

(21) Appl. No.: 18/762,232

(22) Filed: Jul. 2, 2024

(30) Foreign Application Priority Data
Aug. 8, 2023 (JP) 2023-129141

(51) Int. Cl. G02B 6/42; H04B 10/40

(52) U.S. Cl. CPC G02B 6/4249; G02B 6/4246; H04B 10/40

(57) ABSTRACT

An optical device includes a photoelectric conversion element provided on a substrate, and a single mode fiber configured to guide light input to and output from the photoelectric conversion element toward a first direction perpendicular or obliquely upward with respect to the substrate or from the first direction. The single mode fiber has a curved portion that curves with a predetermined radius of curvature. The curved portion converts a propagating direction of the light between the first direction and a second direction that is different from the first direction, and radiates a higher order mode.

### CROSS-REFERENCE TO RELATED APPLICATIONS

This application is based upon and claims the benefit of priority of the prior Japanese Patent Application No. 2023-129141, filed on Aug. 8, 2023, the entire contents of which are incorporated herein by reference.

### FIELD

The embodiments discussed herein are related to optical devices, and optical transceivers.

### BACKGROUND

Data traffic continues to increase in large scale data centers or the like, due to development of the Internet. With the introduction of the fifth generation mobile communication system (“5G” system), and further, the sixth generation mobile communication system (“6G” system), it is expected that data-driven society using artificial intelligence (AI), machine learning, Internet of Things (IoT) for connecting various sensors, autonomous driving, or the like will expand at an accelerated pace. There are demands to realize, by 2030, a technology for implementing a high-speed single core bi-directional optical link using a single mode fiber (SMF) at distances of less than 10 km at a low costs, a low power consumption, and a high density.

In a case where an optical signal having a wavelength in the 1 μm band is transmitted through an SMF in which a chromatic dispersion becomes zero at 1.3 μm (hereinafter also referred to as “1.3 μm SMF”), a higher order mode is generated in a transmission path, and a transmission quality deteriorates due to an intermode interference. A configuration, forming a higher order mode elimination filter by a curved waveguide formed in a planar lightwave circuit on a substrate and disposing this mode elimination filter between a photodetector and the SMF, is known from Japanese Laid-Open Patent Publication No. 2021-189252, for example. A study evaluating a general SMF as a curved fiber mode filter for 1060 nm data transmission has also been reported in Boxuan Zhang, Xiaodong Gu, Susumu Kinoshita and Fumio Koyama, “Bending-Fiber Mode Filter Evaluation for 1060 nm Data Transmission in Conventional Single-Mode Fiber”, Proceedings of Electronics Lectures 1, C-3/4-59, September 2022, for example.

In optical transmission using the SMF, a configuration is required to convert the optical path from a vertical direction to a horizontal direction or from the horizontal direction to the vertical direction between the SMF and a photoelectric conversion element having a light receiving and emitting surface parallel to the substrate, in addition to the eliminating the higher order modes.

### SUMMARY

Accordingly, it is an object in one aspect of the embodiments to provide an optical device capable of eliminating the higher order mode and converting a light propagating direction using a simple configuration.

According to one aspect of the embodiments, an optical device includes a photoelectric conversion element provided on a substrate; and a single mode fiber configured to guide light input to and output from the photoelectric conversion element toward a first direction perpendicular or obliquely upward with respect to the substrate or from the first direction, wherein the single mode fiber has a curved portion that curves with a predetermined radius of curvature, and the curved portion converts a propagating direction of the light between the first direction and a second direction that is different from the first direction, and radiates a higher order mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of an optical device according to a first embodiment;

FIG. 2 is a diagram illustrating an example of a photoelectric conversion element used in the optical device;

FIG. 3 is a schematic diagram of the optical device according to a second embodiment;

FIG. 4 is a schematic diagram of the optical device according to a third embodiment;

FIG. 5A is a schematic diagram of the optical element according to a fourth embodiment;

FIG. 5B is a schematic diagram of a V-groove for holding an SMF;

FIG. 6 is a schematic diagram of the optical device according to a fifth embodiment; and

FIG. 7 is a block diagram of an optical transceiver using the optical device.

### DESCRIPTION OF EMBODIMENTS

Preferred embodiments of the present invention will be described with reference to the accompanying drawings.

In the embodiments, a single mode fiber (SMF) to be optically connected to a photoelectric conversion element provided on a substrate is bent with a predetermined radius of curvature and used, to thereby function as a direction converter configured to convert a light propagating direction between a vertical direction and a horizontal direction, and also function as a higher order mode filter configured to eliminate a higher order mode. The SMF is used for configuring a single core bi-directional optical link having a transmission rate of 100 Gbps or higher. In the 5G system, 100 5G antenna base stations are required within a cell having a radius of 2 km. In the 6G system, the use of a higher frequency band and a reduced cell radius are expected compared to the 5G system. If the cell radius of the 6G system is assumed to be 20 m, 10,000 6G cells or 6G antenna base stations are required within the cell having a radius of 2 km. In 6G system, a transmission rate higher than 100 Gbps, that is, a transmission rate of 1 Tbps or higher is expected.

The base stations of the conventional third generation mobile communication system (“3G” system) to the fourth generation mobile communication system (“4G” system) are installed in or near a building of a communication carrier, and these base stations are connected to a network. When installing the base stations of the 5G system or the 6G system, a so-called optical front haul, in which optical fibers are extended from the base stations of the 3G system or the 4G system (including LTE for the sake of convenience) or from the building of the communication carrier as starting points, is introduced. There are demands for an efficient optical front haul using an SMF having a longer transmission distance and a lower cost compared to a multi mode fiber (MMF).

In the SMF, when a transmission wavelength becomes shorter than a cutoff wavelength, the higher order mode is also transmitted in addition to a fundamental mode. The cutoff wavelength is a shortest wavelength that can propagate only in a single mode. When the higher order mode is included in the transmission, a signal waveform deterioration occurs due to an intermode interference, and therefore, and thus, a higher order mode filter is required to eliminate the higher order mode. Because the signal waveform deterioration becomes more conspicuous as a bit rate of the transmission becomes higher, the elimination of the higher order mode is required.

In a case where a conventional mode filter formed of a planar lightwave circuit is used, a light emitting element or a light receiving element is optically connected to an optical fiber using a lens or the like, and the optical fiber is fusion-spliced to the mode filter. An optical coupling loss between the optical fiber and the mode filter increases, and a number of components increases. In order to solve this problem, in one embodiment, a simple and low-cost configuration is implemented by a “mode filtering optical coupling” which eliminates the higher order mode by utilizing bending (or curve) of the optical fiber.

Hereinafter, specific configurations and methods of delay control according to the embodiments will be described with reference to the drawings. The following embodiments are examples for implementing a technical concept of the present disclosure, and the present disclosure is not limited to these examples. Sizes, positional relationships, or the like of constituent elements illustrated in the drawings may be exaggerated for the sake of facilitating the understanding of the present disclosure. The constituent elements having the same configuration or function are designated by the same names or reference numerals, and a redundant description thereof may be omitted.

### First Embodiment

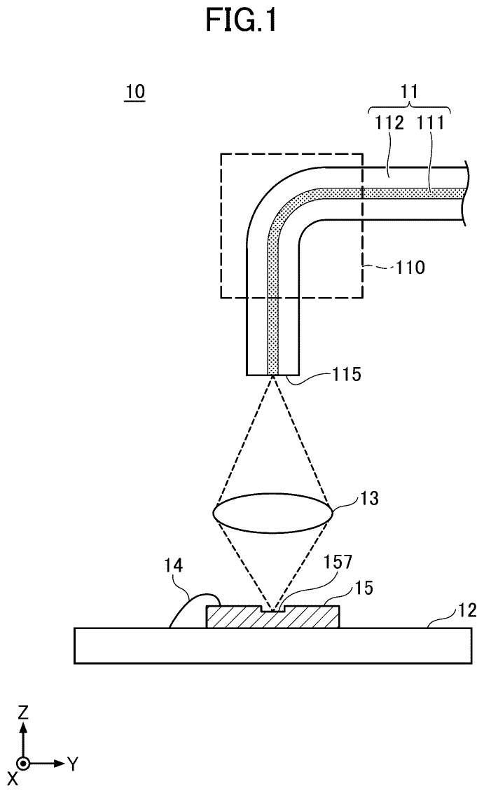

FIG. 1 is a schematic diagram of an optical device 10 according to a first embodiment. The optical device 10 includes a photoelectric conversion element 15 provided on a substrate 12, and an SMF 11 for guiding light input to and output from the photoelectric conversion element 15 from or to a first direction perpendicular or obliquely upward with respect to a front surface (upper surface in FIG. 1) of the substrate 12. The photoelectric conversion element 15 is electrically connected to an interconnect formed on the substrate 12 via a bonding wire 14, for example, but may be wire-bonded to an electronic chip, such as a driver, a transimpedance amplifier (TIA), or the like provided adjacent to the photoelectric conversion element 15 on the substrate 12. The SMF 11 has a curved (or bent) portion 110 curved (or bent) with a predetermined radius of curvature, and the curved portion 110 converts a propagating direction of light between the first direction perpendicular or obliquely upward with respect to the substrate 12 and a second direction different from the first direction, and radiates the higher order mode. The second direction is a direction parallel to the substrate 12, for example.

In a coordinate system of FIG. 1, a plane parallel to the front surface of the substrate 12 is defined as an XY-plane, and a direction perpendicular with respect to the substrate 12 is defined as a Z-direction. The curved portion 110 converts the propagating direction of light between the first direction (Z-direction) perpendicular to the substrate 12 and the second direction in the XY-plane, radiates the higher order mode, and propagates the fundamental mode. The first direction does not necessarily have to be exactly 90° with respect to the front surface of the substrate 12, and includes a direction of 90°±10° with respect to the front surface of the substrate 12, according to manufacturing errors of the substrate 12 and the photoelectric conversion element 15, a curved (or bent) state of the SMF 11, or the like. Similarly, the second direction does not necessarily have to be perfectly parallel to the front surface of the substrate 12, and includes a direction of 180°±10° with respect to the front surface of the substrate 12, according to the manufacturing error of the substrate 12, the curved state and held state of the SMF 11, or the like.

A diameter of the SMF 11, that is, an outer diameter of a cladding 112, is typically 125 μm, and a diameter of a core 111 is in a range of 7 μm to 10 μm. The SMF 11 has a step index (SI) type refractive index distribution, such that a pulse propagating through the core 111 having the small diameter and high refractive index has a small spread, and thus, a long distance transmission is possible compared to a multi mode fiber (MMF).

The direction of the SMF 11 is converted by approximately 90° at the curved portion 110, and an end surface 115 of the fiber opposes a light receiving and emitting surface of the photoelectric conversion element 15 provided on the substrate 12. A lens 13 may be disposed between the end surface 115 of the fiber and the photoelectric conversion element 15. In a case where the photoelectric conversion element 15 is a vertical cavity surface emitting laser (VCSEL), light emitted from the photoelectric conversion element 15 is concentrated, by the lens 13, on the core 111 at a position of the end surface 115. In a case where the photoelectric conversion element 15 is a light receiving element, such as a photodiode or the like, the light emitted from the core 111 at the end surface 115 is concentrated, by the lens 13, on the light receiving surface of the light receiving element.

The SMF generally used in optical communication is a 1.3 μm band zero dispersion SMF prescribed under G652 of the ITU-T standard, but a limit value of a bending radius (or curve radius) of this SMF is approximately 30 mm. When bending radius of this SMF is set to 30 mm or less and the direction is converted by 90°, there is a concern for an increase in the bending loss and a physical damage. It may seem desirable to use a low bending loss SMF recommended under G657 of the ITU-T standard as the SMF 11 having the curved portion 110, but in the embodiments, an SMF having a bending loss difference between the fundamental mode and the higher order mode to a certain extent or greater is used, instead of using the low bending loss SMF.

In order to propagate the light of the fundamental mode with a low loss and effectively eliminate the higher order mode in the curved portion 110, it is desirable for the bending loss difference between the fundamental mode and the higher order mode to be sufficiently large. The bending loss difference between the fundamental mode and the higher order mode is 15 dB or greater, preferably 18 dB or greater, and more preferably 20 dB or greater, for example. As a result of diligent studies conducted by the present inventors, it was found that, when a low bending loss fiber is used, the bending loss of the higher order mode also decreases, thereby making it difficult to effectively eliminate the higher order mode by the curved portion 110. Accordingly, the embodiments use an SMF having a large bending loss with respect to the higher order mode and a negligibly small bending loss with respect to the fundamental mode.

In Boxuan Zhang, Xiaodong Gu, Susumu Kinoshita and Fumio Koyama, “Bending-Fiber Mode Filter Evaluation for 1060 nm Data Transmission in Conventional Single-Mode Fiber”, Proceedings of Electronics Lectures 1, C-3/4-59, September 2022, the bending loss with respect to an LP01 mode, which is the fundamental mode, is reduced to a negligible level by making the bending radius greater than the 6 mm, when performing the calculation using the SMF prescribed under G652. However, when the bending radius is greater than 7 mm, the bending loss with respect to an LP11 mode, which is the higher order mode, also decreases, and the bending loss difference between the L11 mode and the LP01 mode cannot be secured to 15 dB or greater, preferably 18 dB or greater, and more preferably 20 dB or greater. In actual specifications, the limit value of the bending radius of the SMF prescribed under G652 is set to 30 mm, and thus, the fiber may break when the bending radius is set to 7 mm.

The present inventors, through calculations using various SMFs, found that the bending loss difference between the LP11 mode and the LP01 mode can be 15 dB or greater, preferably 18 dB or greater, and more preferably 20 dB or greater by bending and using the SMF with a bending radius within a certain range. In particular, in a case where an SMF having a bending resistance with respect to the fundamental mode is used, the bending loss difference between the fundamental mode (LP01 mode) and the higher order mode (LP11 mode) can be 20 dB or greater by setting the bending radius in a range greater than or equal to 3 mm and less than or equal to 7 mm. Even in the case of an SMF having the bending resistance with respect to the fundamental mode, when the bending radius becomes less than the 3 mm, the bending loss of the fundamental mode increases, and the bending loss difference between the fundamental mode and the higher order mode becomes less than 15 dB, and a possibility of the physical damage to the fiber occurring increases.

By using such an SMF that is bent (or curved) with a bending radii (or curve radii) of 3 mm or greater and 7 mm or greater, the propagating direction of light can be converted between two different directions, that is, between the direction perpendicular to the substrate 12 and the direction parallel to the substrate 12, for example, the higher order mode can be radiated at the curved portion 110. The cutoff wavelength of the 1.3 μm band SMF is 1.26 μm. In the optical transmission in a T band in which the communication wavelength is shorter than 1.26 μm, the higher order mode is generated in the 1.3 μm band SMF. In the configuration illustrated in FIG. 1, the SMF 11 used has the bending loss of the higher order mode larger than the bending loss of the fundamental mode by 15 dB or greater. By bending and using the SMF 11 with the bending radius in the range greater than or equal to 3 mm and less than or equal to 7 mm, the propagating direction can be converted, and the higher order mode can be eliminated, so that the fundamental mode can be transmitted with a small loss.

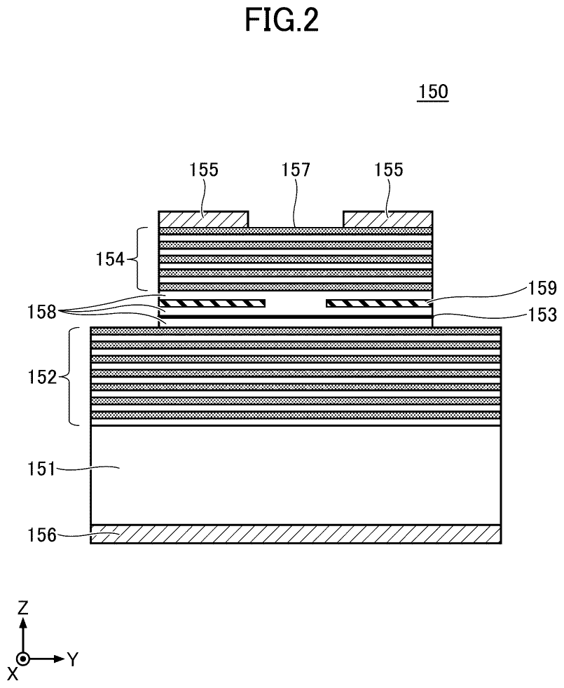

FIG. 2 is a schematic diagram of a light emitting element 150, as an example of the photoelectric conversion element 15 used in the optical device 10. The light emitting element 150 is a VCSEL which emits light in the direction perpendicular to the substrate 12, for example. The light emitting element 150 can be formed of a GaAlAs-based material or an InGaAs-based material in a case where the VCSEL is used with the 1.3 μm band SMF 11. The VCSEL includes an n-type multilayer film reflection mirror 152, an active layer 153, and a p-type multilayer film reflection mirror 154 which are laminated in a direction perpendicular to the substrate 151, and a resonator (cavity) is formed in the direction perpendicular to the substrate 151. A current constriction layer 159 may be inserted between the active layer 153 and the p-type multilayer film reflection mirror 154, to increase a gain distribution in a region located below a light emitting surface 157. In this case, a distance (or separation) between the active layer 153 and the current constriction layer 159 is adjusted by a spacer layer 158, so that an antinode of a standing wave is located in the active layer 153 and a node of the standing wave is located in the current constriction layer 159.

A p-type anode electrode 155 is provided on a front surface of the p-type multilayer film reflection mirror 154, and an n-type cathode electrode 156 is provided on a back surface of the substrate 151. A surface exposed inside an opening of the anode electrode 155 serves as the light emitting surface 157. A size of the light emitting surface 157 may be designed to fall within a range of 7 μm to 10 μm, so that a mode field diameter of the emitted light matches a core diameter of the SMF 11.

In a case where the GaAlAs-based material is used, the substrate 151 may be formed of an n-type GaAs substrate, and the multilayer film reflection mirrors 152 and 154 may be formed of a distributed Bragg reflector (DBR) in which GaAs and AlAs having different refractive indexes are alternately laminated. The active layer 153 is formed of a multi quantum well (MQW) having a GaAs well layer and an AlGaAs barrier layer, a MQW having a GaAsSb well layer and a GaAs barrier layer, a MQW having a GaInNAs well layer and a GaAs barrier layer, or the like. The current constriction layer 159 may be formed of an oxide of AlAs. The 1.3 μm band VCSEL may be formed of an InP-based material instead of using the GaAs-based material.

Because the VCSEL emits light in the direction perpendicular to the substrate 12, a direct modulation method is employed when the optical device 10 is applied to an optical transceiver, as will be described later. By controlling on and off states of a current injected from the anode electrode 155 and the cathode electrode 156 of the light emitting element 150 into the active layer 153, the output light is directly modulated. In the light emitting element 150, a modulation current may be controlled to on and off state, in a state where a predetermined bias current is applied between the anode electrode 155 and the cathode electrode 156.

The light emitted from the light emitting element 150 is concentrated, by the lens 13, on the core 111 at the end surface 115 of the SMF 11. When the injection current is increased to increase an output power of the light emitting element 150, the light emitting element 150 is more likely to oscillate in a multi mode. Even when the light emitting element 150 is oscillates in a single mode, the light incident to the SMF 11 at the wavelength shorter than the cutoff wavelength of the SMF 11 may include the higher order mode, but the higher order mode is radiated at the curved portion 110, and the modulated light of the fundamental mode propagates in the direction parallel to the substrate 12. Thus, the intermode interference is reduced, and the waveform of the signal light can be maintained in a satisfactory state.

### Second Embodiment

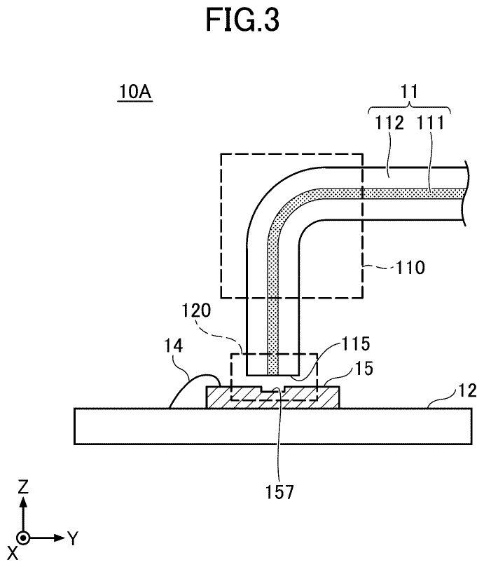

FIG. 3 is a schematic diagram of an optical devices 10A according to a second embodiment. In the second embodiment, the lens 13 is omitted, and the SMF 11 and the photoelectric conversion element 15 are optically coupled by a butt joint. The optical device 10A includes the photoelectric conversion element 15 provided on the substrate 12, and the SMF 11 configured to guide light input to and output from the photoelectric conversion element 15 from or to the first direction perpendicular to or obliquely above the front surface of the substrate 12. The photoelectric conversion element 15 is electrically connected to the interconnect formed on the substrate 12 via the bonding wire 14, for example, but may be wire-bonded to an electric chip, such as a driver, a transimpedance amplifier (TIA), or the like provided adjacent to the photoelectric conversion element 15 on the substrate 12. The SMF 11 has the curved (or bent) portion 110 curved (or bent) with a predetermined radius of curvature, and the curved portion 110 converts the propagating direction of the light between the first direction perpendicular or obliquely upward with respect to the substrate 12 and the second direction different from the first direction (for example, in the direction parallel to the substrate 12), and radiates the higher order mode.

The end surface 115 of the SMF 11 and the light receiving and emitting surface of the photoelectric conversion element 15 are optically coupled by a butt joint 120. In the case where the photoelectric conversion element 15 is a VCSEL, the light emitting surface 157 of the VCSEL and the end surface 115 of the SMF 11 are directly optically coupled by the butt joint 120. In a case where there is no misalignment between a center axis (optical axis) of the core 111 of the SMF 11 and a center of the light emitting surface 157 of the VCSEL, a coupling loss is several dB or less even if the distance between the end surface 115 of the SMF 11 and the light emitting surface 157 of the VCSEL in the Z-direction is approximately 100 μm. Even if there is a misalignment of approximately +1 μm between the optical axis of the SMF 11 and an optical axis of the light emitting surface 157, the optical coupling can be achieved with a coupling loss of 2 dB or less as long as the distance between the end surface 115 of the SMF 11 and the light emitting surface 157 of the VCSEL is 60 μm or less.

The optical device 10A according to the second embodiment can convert the propagating direction of the light between the direction perpendicular and the direction parallel with respect to the substrate 12, and remove the higher order mode, using a simple configuration in which the number of components is reduced and the SMF 11 itself has the curved portion 110.

In the configuration of the second embodiment illustrated in FIG. 3, the loss can be calculated using a model having the opposite end surface of the SMF 11 optically coupled, by a butt joint, to the light receiving surface of the optical device 10A having the photodiode provided thereon. For comparison purposes, the loss is calculated for a model of a comparative example having a VCSEL and a regular 1.3 μm band SMF optically coupled via a lens, the SMF fusion-spliced to a mode filter of a planar lightwave circuit, the SMF connected to another SMF on an emitting side of a mode filter, and optically coupled to a light receiving surface of a photodiode via a lens.

In the comparative example, the configuration includes VCSEL→lens→SMF→mode filter→SMF→transmission path→SMF→mode filter→SMF→lens→photodiode. The components used include two lenses, four SMFs, and two mode filters.

The coupling loss between the VCSEL and the SMF is 1.0 dB, and the coupling loss at connecting parts between the mode filter and the two SMFs is 1.4 dB (the loss of the mode filter itself is 0.3 dB, the coupling loss of the SMF on both sides of the mode filter is 1.0 dB, and a splice loss is 0.1 dB). In the configuration of the comparative example, a total loss on a transmission side is 2.4 dB.

On a reception side of the comparative example, the coupling loss between the SMF and the light receiving surface of the photodiode is 0.5 dB, and the coupling loss at the connecting parts between the mode filter and the two SMFs is 1.4 dB (the loss of the mode filter itself is 0.3 dB, the coupling loss of the SMFs on both sides of the mode filter is 1.0 dB, and the splice loss is 0.1 dB). In the configuration of the comparative example, the total loss on the reception side is 1.9 dB.

In contrast, the optical device 10A according to the second embodiment has a configuration including VCSEL→SMF (butt joint)→transmission path→SMF (butt joint)→photodiode. The components used are only the two SMF 11 having the curved portion 110.

On the transmission side of the optical device 10A, the coupling loss at the butt joint 120 between the VCSEL and the SMF is 1.0 dB, the bending loss at the curved portion 110 with respect to the fundamental mode is 0.5 dB, and the total loss is 1.5 dB. The total loss of the transmission side is improved by 0.9 dB compared to the total loss of the transmission side of the comparative example, namely, 2.4 dB.

On the receiving side of the optical device 10A, the coupling loss at the butt joint between the SMF and the photodiode is 0.5 dB, the bending loss with respect to the fundamental mode at the curved portion 110 is 0.5 dB, and the total loss is 1.0 dB. The total loss on the receiving side is improved by 0.9 dB compared to the total loss of the receiving side of the comparative example, namely, 1.9 dB. When the transmission side and the reception side of the optical device 10A are combined, the loss improvement effect is 1.8 dB, and six components can be reduced compared to the comparative example.

The optical device 10A according to the second embodiment can convert the direction of the optical transmission and eliminate the higher order mode, using a simple configuration. In the optical device 10 according to the first embodiment, the number of components is larger than that of the second embodiment due to the use of the lens 13, but four components can still be reduced compared to the configuration of the comparative example, and the loss improvement effect obtainable in the first embodiment is similar to that obtainable in the second embodiment.

### Third Embodiment

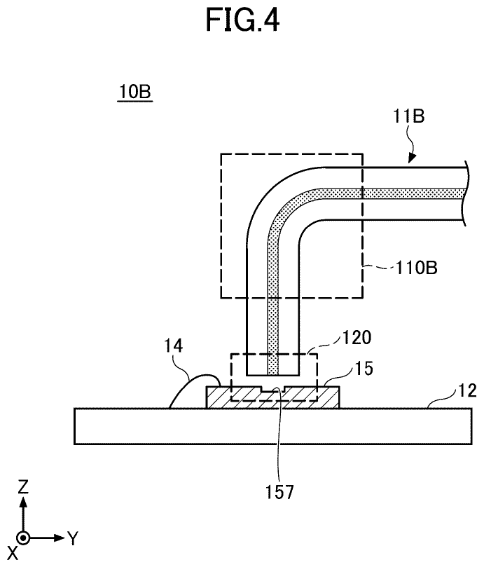

FIG. 4 is a schematic diagram of an optical devices 10B according to a third embodiment. The third embodiment utilizes a fixed-curve (fixed-bend) fiber which is fixed to a predetermined bend radius by relaxing stress by a heat treatment. The fixed-curve fiber is used for converting the light emitting direction in a silicon photonics circuit, and the limit value of the bending radius is approximately 2.5 mm. In an existing fixed-curve fiber, the bending loss difference between the higher order mode and the fundamental mode is approximately 0.1 dB with the bend radius of 3 mm, and the fundamental mode and the higher order mode cannot be separated. In the third embodiment, the fixed-curve fiber is used, but a loss characteristic is adjusted so that the bending loss difference between the higher order mode and the fundamental mode becomes greater than or equal to 15 dB. As an adjustment method, a trench-type index profile of an existing low-loss fixed-curve fiber is varied to a step-type index profile in the third embodiment, and a mode field diameter is adjusted so that the bending loss becomes a desired characteristic.

The optical device 10B includes the photoelectric conversion element 15 provided on the substrate 12, and an SMF 11B configured to guide light input to and output from the photoelectric conversion element 15 from or to the first direction perpendicular to or obliquely above the front surface of the substrate 12. The SMF 11B is a fixed-curve fiber having an index profile thereof adjusted and a radius of curvature thereof fixed to a predetermined radius of curvature by relaxing the stress by the heat treatment. The photoelectric conversion element 15 is electrically connected to the interconnect formed on the substrate 12 via the bonding wire 14, for example, but may be wire-bonded to an electric chip, such as a driver, a transimpedance amplifier (TIA), or the like provided adjacent to the photoelectric conversion element 15 on the substrate 12. The SMF 11B has a curved (or bent) portion 110B having the fixed predetermined radius of curvature. The bent portion 110B converts the propagating direction of the light between the first direction perpendicular or obliquely upward with respect to the substrate 12 and the second direction different from the first direction (for example, in the direction parallel to the substrate 12), and radiates the higher order mode.

The use of the fixed curve fiber, having the relaxed stress and adjusted index profile, can reduce the possibility of physical damage to or failure of the SMF 11B, and maintain a reliability of the optical coupling. The optical device 10B, similar to the optical devices 10 and 10A, converts the light propagating direction by approximately 90°, radiates the higher order mode at the curved portion 110B, and propagates the fundamental mode with a low loss.

### Fourth Embodiment

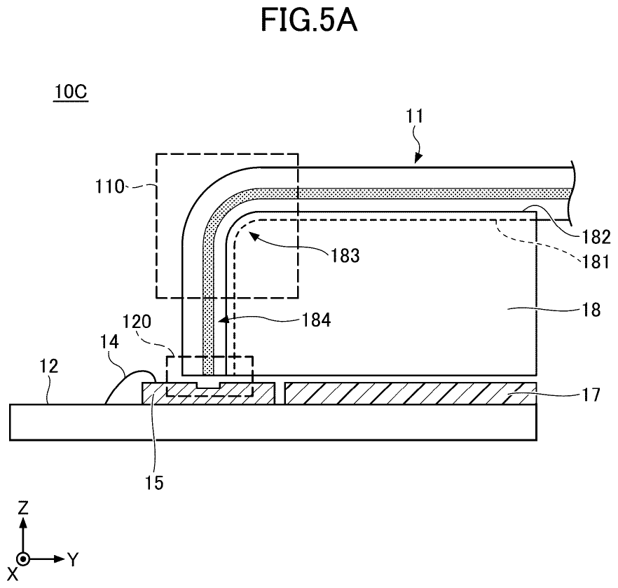

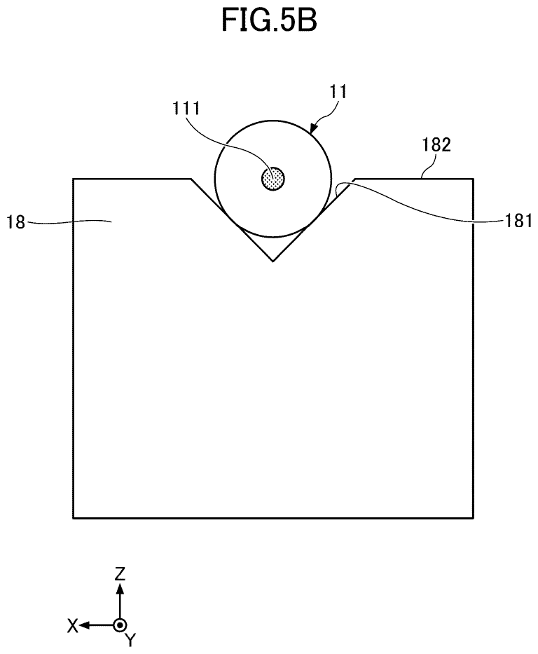

FIG. 5A is a schematic diagram of an optical device 10C according to a fourth embodiment. In the fourth embodiment, the SMF 11 is held by a fiber guide block 18. The fiber guide block 18 has a top surface 182, a front surface 184 adjacent to the photoelectric conversion element 15, and a curved corner portion 183 connecting the top surface 182 and the front surface 184. The fiber guide block 18 is formed with a groove 181 extending from the top surface 182 through the corner portion 183 to at least a portion of the front surface 184. By fitting the SMF 11 into the groove 181, the curved portion 110 curved with a predetermined radius of curvature is formed on the SMF 11, and the SMF 11 can be accurately positioned and aligned with respect to the photoelectric conversion element 15.

The corner portion 183 of the fiber guide block 18 is curved so that the SMF 11 has the curved portion 110 with the predetermined radius of curvature. The radius of curvature of the curved portion 110 of the SMF 11 is set to a value so that the bending loss difference between the higher order mode and the fundamental mode becomes greater than or equal to 15 dB, preferably greater than or equal to 18 dB, and more preferably greater than or equal to 20 dB. Thus, the fundamental mode of the light input to and output from the photoelectric conversion element 15 can be transmitted with a low loss, and the higher order mode can be radiated from the SMF 11.

A support layer 17 may be formed on the substrate 12 to adjust a height of the fiber guide block 18. The support layer 17 is formed of an adhesive, a resin, an insulator, or the like. By matching a thickness of the support layer 17 to the height of the photoelectric conversion element 15, the SMF 11 held by the fiber guide block 18 and the photoelectric conversion element 15 can be optically coupled by the butt joint 120.

FIG. 5B is a schematic diagram of the groove 181 for holding the SMF 11. The groove 181 illustrated in FIG. 5B is a V-groove, but may be a groove having a semicircular or U-shaped cross section. By fitting the SMF 11 into the groove 181, the SMF 11 can be held stably, and the curved portion 110 having the designed radius of curvature can be formed. Thus, the propagating direction of the light is converted between the first direction perpendicular to the substrate 12 and the second direction parallel to the substrate 12, the higher order mode is radiated, and the fundamental mode is transmitted with a low loss.

### Fifth Embodiment

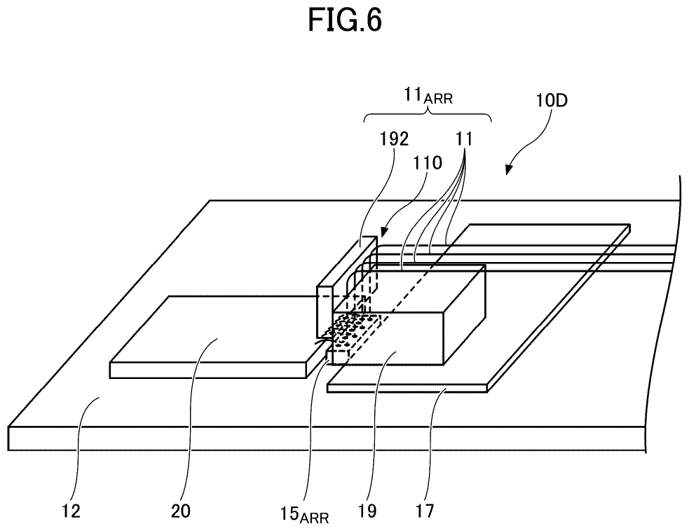

FIG. 6 is a schematic diagram of an optical device 10D according to a fifth embodiment. In the fifth embodiment, a fiber array 11_{ARR} Carrying a plurality of SMFs 11 is optically coupled to a photoelectric conversion element array 15_{ARR} provided on the substrate 12. The fiber array 11_{ARR} includes a fiber holder 192 for holding a plurality of SMFs 11. The fiber holder 192 is formed with a plurality of grooves for individually holding the plurality of SMF 11 at predetermined intervals, and the SMFs 11 are held in the grooves of the fiber holder 192.

The fiber holder 192 is fixed to the substrate 12 so that an end surface of each SMF 11 opposes a corresponding photoelectric conversion element of the photoelectric conversion element array 15_{ARR}. Each SMF 11 and the corresponding photoelectric conversion element may be optically coupled by a butt joint. Alternatively, a microlens array for concentrating light may be disposed between the fiber array 11_{ARR} and the photoelectric conversion element array 15_{ARR}.

The portion of the SMF 11 held by the fiber holder 192 extends in a direction approximately perpendicular to the substrate 12, changes direction by approximately 90° at the curved portion 110, and extends in a direction parallel to the substrate 12. Each SFM 11 may be a fixed-curve fiber that has been pre-adjusted of the index profile thereof and fixed to a predetermined radius of curvature in a state relaxed of the stress by a heat treatment. In this case, damage to each SMF 11 at the curved portion 110 can be reduced, and the higher order mode can be radiated to propagate the fundamental mode with a low loss.

In order to stably hold the portion of the SMF 11 extending in the direction parallel to the substrate 12, a fiber guide block 19 may be disposed on the substrate 12. A support layer 17 may be formed on the substrate 12 for adjusting the height of the fiber guide block 19. Each photoelectric conversion element of the photoelectric conversion element array 15_{ARR} is electrically connected to the electric circuit chip 20 provided on the substrate 12. The photoelectric conversion element array 15_{ARR} and the electric circuit chip 20 may be connected to each other by bonding wires or may be connected to each other by an interconnect formed on the substrate 12.

### <Example of Application to Optical Transceiver>

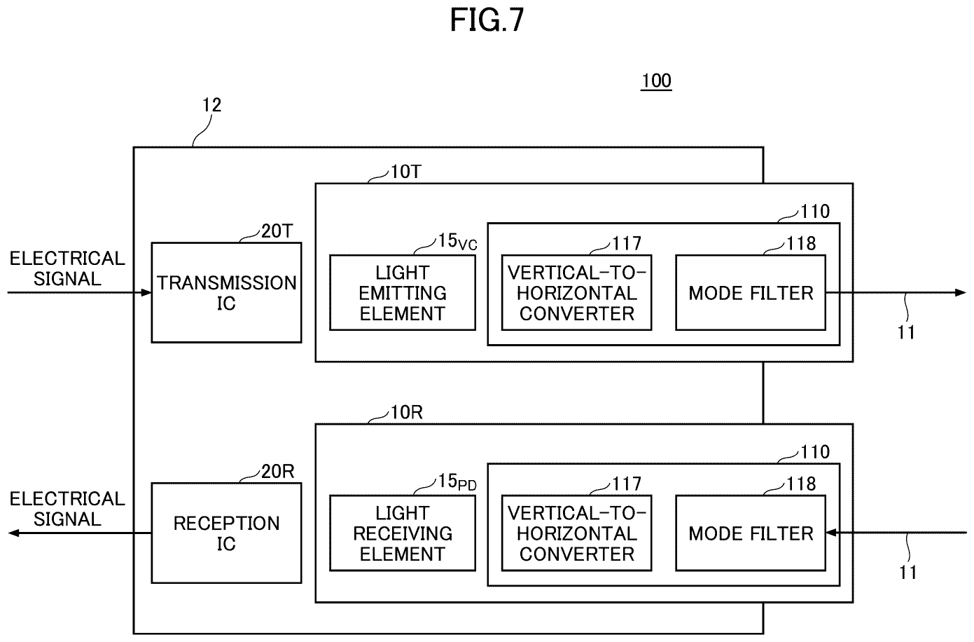

FIG. 7 is a block diagram of an optical transceiver 100 using the optical device according to the embodiment. The optical transceiver 100 includes a transmission-side optical device 10T and a reception-side optical device 10R that are provided on the substrate 12. The transmission-side optical device 10T includes a light emitting element 15_{VC}, and an SMF 11 optically coupled to the light emitting element 15_{VC}. The SMF 11 has a curved portion 110 on the light imaging side with respect to the light emitting element 15_{VC}. The curved portion 110 functions as a vertical-to-horizontal converter 117 configured to convert the propagating direction of light between the vertical direction and the horizontal direction with respect to the substrate 12, and also functions as a mode filter 118 that eliminates the higher order mode. In the mode filter 118, the bending loss difference between the higher order mode and the fundamental mode is 15 dB or greater, preferably 18 dB or greater, and more preferably 20 dB or greater.

The reception-side optical device 10R includes a light receiving element 15_{PD}, and an SMF 11 optically coupled to the light receiving element 15_{PD}. The SMF 11 has a curved portion 110 on the light imaging side with respect to the light receiving element 15_{PD}. The curved portion 110 functions as a vertical-to-horizontal converter 117 configured to convert the propagating direction of light between the vertical direction and the horizontal direction with respect to the substrate 12, and also functions as a mode filter 118 that eliminates the higher order mode. In the mode filter 118, the bending loss difference between the higher order mode and the fundamental mode is 15 dB or greater, preferably 18 dB or greater, and more preferably 20 dB or greater.

The optical transceiver 100 has a transmission IC 20T connected to the transmission-side optical device 10T, and a reception IC 20R connected to the reception-side optical device 10R. The transmission IC 20T is an example of the electric circuit chip 20, and includes a driver circuit that drives the light emitting element 15_{VC}, for example. The transmission IC 20T including the driver circuit generates and outputs a modulation drive signal for directly modulating the light emitting element 15_{VC}, based on a data signal input from a large scale integrated circuit (LSI), such as a digital signal processor (DSP) or the like.

The reception IC 20R is an example of the electric circuit chip 20, and includes a TIA that converts a photocurrent output from a light receiving element 15_{PD} into a voltage signal and amplifies the voltage signal. The voltage signal output from the TIA is supplied to the DSP and other LSIs.

In the optical transceiver 100, the direction of the transmission path is converted between the vertical direction and the horizontal direction on each of the transmission side and the reception side, and the higher order mode is eliminated by propagating the fundamental mode with a low loss. Accordingly, it is possible to reduce the intermode interference, and maintain the waveform of the optical signal. The entire optical transceiver 100 may be accommodated inside a housing, together with the substrate 12. Because the direction of the SMF 11 is converted by approximately 90° at the curved portion 110 with a small bending radius in a range of 3 mm to 7 mm, the size of the optical transceiver 100 including the casing can be reduced.

Although the configuration of the optical device 10 for eliminating the higher order mode is described above based on specific configuration examples, the present disclosure is not limited to the configuration examples. The configurations of the embodiments may be arbitrarily combined. In each of the embodiments, an SMF relaxed of the stress by the heat treatment may be used, or a fiber array in which a plurality of SMF 11 are arranged may be used. Even in cases where the photoelectric conversion element 15 operates at a wavelength shorter than or equal to the cutoff wavelength of the SMF 11 or the higher order mode is generated in the transmission path, the higher order mode can be eliminated by the curved portion 110, and the optical signal quality can be maintained.

According to the embodiments, it is possible to provide an optical device capable of eliminating the higher order mode and converting a light propagating direction using a simple configuration.

The description above use terms such as “determine”, “identify”, or the like to describe the embodiments, however, such terms are abstractions of the actual operations that are performed. Hence, the actual operations that correspond to such terms may vary depending on the implementation, as is obvious to those skilled in the art.

Although the embodiments are numbered with, for example, “first,” “second,” “third,” “fourth,” or “fifth,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a photoelectric conversion element provided on a substrate; and
a single mode fiber configured to guide light input to and output from the photoelectric conversion element toward a first direction perpendicular or obliquely upward with respect to the substrate or from the first direction, wherein
the single mode fiber has a curved portion that curves with a predetermined radius of curvature, and
the curved portion converts a propagating direction of the light between the first direction and a second direction that is different from the first direction, and radiates a higher order mode.

2. The optical device as claimed in claim 1, wherein the second direction is a direction parallel to the substrate.

3. The optical device as claimed in claim 1, wherein the predetermined radius of curvature of the curved portion is in a range greater than or equal to 3 mm and less than or equal to 7 mm.

4. The optical device as claimed in claim 1, wherein a difference between a bending loss of the higher order mode and a bending loss of a fundamental mode in the curved portion is greater than or equal to 15 dB.

5. The optical device as claimed in claim 1, wherein the photoelectric conversion element is a vertical cavity surface emitting laser or a photodiode having a light receiving surface parallel to the substrate.

6. The optical device as claimed in claim 1, wherein the single mode fiber is a fixed-curve fiber fixed to the predetermined radius of curvature in a state where stress is relaxed by a heat treatment.

7. The optical device as claimed in claim 1, wherein the single mode fiber and the photoelectric conversion element are optically coupled by a butt joint.

8. The optical device as claimed in claim 1, further comprising:
a lens disposed between the photoelectric conversion element and the end surface of the single mode fiber,
wherein the lens concentrates the light emitted from the photoelectric conversion element on a core of the single mode fiber, or concentrates the light emitted from the core of the single mode fiber on a light receiving surface of the photoelectric conversion element.

9. The optical device as claimed in claim 1, wherein
the single mode fiber is an optical fiber for a 1.3 μm band, and
the photoelectric conversion element operates in a wavelength band less than or equal to 1.26 μm, which is a cutoff wavelength of the single mode fiber.

10. The optical device as claimed in claim 1, further comprising:
a fiber guide block provided on the substrate and configured to guide the single mode fiber,
wherein the fiber guide block has a curved corner portion configured to hold the curved portion of the single mode fiber.

11. The optical device as claimed in claim 1, further comprising:
a fiber holder configured to hold a plurality of single mode fibers; and
a photoelectric conversion element array including an array of a plurality of photoelectric conversion elements,
wherein each single mode fiber of the plurality of single mode fibers has the curved portion.

12. An optical transceiver comprising:
the optical device according to claim 1; and
an electric circuit provided on the substrate and configured to input and output an electric signal between the photoelectric conversion element and the electric circuit.

13. The optical transceiver as claimed in claim 12, wherein
the electric circuit generates a drive signal for driving the photoelectric conversion element, and
the photoelectric conversion element is directly modulated by the drive signal and outputs an optical signal.
